(19) United States
(12) Patent Application Publication
(10) Pub. No.: US 2024/0371214 A1
(43) Pub. Date: Nov. 7, 2024

(54) AUTOMATED TELEMATICS DATA LOGGER SYSTEM

(71) Applicant: Cummins Inc., Columbus, IN (US)

(72) Inventors: Gregory L. Emerick, Columbus, IN (US); Girish Chandramouli, Carmel, IN (US); Loran David Radle, Columbus, IN (US); Brad Curtis Sutton, Columbus, IN (US); Nathan McLeese, Columbus, IN (US); Joyer Benedict Lobo, Greenwood, IN (US)

(73) Assignee: Cummins Inc., Columbus, IN (US)

(21) Appl. No.: 18/642,743

(22) Filed: Apr. 22, 2024

Related U.S. Application Data
(60) Provisional application No. 63/464,344, filed on May 5, 2023.

(51) Int. Cl. G07C 5/08; G07C 5/00

(52) U.S. Cl. CPC G07C 5/0808; G07C 5/008

(57) ABSTRACT

Systems, methods, and apparatuses for automatically logging telematics data are provided herein. An apparatus includes one or more processors, and one or more memory devices storing instructions that, when executed by the one or more processors, cause the one or more processors to: receive access information from a remote computing system, the access information comprising information indicative of a data type and a logging duration; and, log telematics data that corresponds to the data type. Logging the telematics data includes: storing the telematics data that corresponds to the data type in a buffer for the logging duration; monitoring for a fault code; responsive to not detecting the fault code, causing the buffer to delete a portion of the telematics data; and responsive to detecting the fault code, providing the telematics data to the remote computing system.

### CROSS-REFERENCE TO RELATED APPLICATION

This application claims the benefit of and priority to U.S. Provisional Application No. 63/464,344, filed May 5, 2023, which is incorporated herein by reference in its entirety and for all purposes.

### TECHNICAL FIELD

The present disclosure relates to systems and methods for automated telematics data logging for a fleet and/or individual vehicles or stationary equipment (e.g., generator sets) or components thereof, such as powertrains, using a remote computing system.

### BACKGROUND

Vehicles used in on-road and/or off-road applications and/or stationary equipment, such as generator sets (“gensets”), may include an electronic control unit(s) (e.g., an engine control unit (ECU), an engine control module (ECM), etc.). The electronic control unit may be configured to provide an indication of an issue with the vehicle or stationary equipment (referred to herein as a “fault code”) according to a predetermined standard, such as the SAE J1939 standard. However, the fault code may merely provide notice of the issue and not provide sufficient data to accurately diagnose the issue. Further, there may be a time period between receiving the fault code and logging data related to the fault code corresponding to a time period after an issue occurred. For example, a duty cycle of the vehicle or equipment may have changed between the receipt of the fault code and when the data logging began. Thus, the logged data associated with the fault code may be of limited value in terms of troubleshooting the triggered fault code.

### SUMMARY

One embodiment relates to an apparatus. The apparatus includes one or more processors and one or more memory devices storing instructions that, when executed by the one or more processors, cause the one or more processors to: receive access information from a remote computing system, the access information comprising information indicative of a data type and a logging duration; log telematics data that corresponds to the data type, wherein logging the telematics data comprises: storing the telematics data that corresponds to the data type in a buffer for the logging duration; monitoring for a fault code; responsive to not detecting the fault code, causing the buffer to delete a portion of the telematics data; and responsive to detecting the fault code, providing the telematics data to the remote computing system.

Another embodiment relates to a method for automatically logging telematics data for a fleet of vehicles. The method includes receiving, by a processing circuit of a computing system, an indication of a first fault code from a first vehicle of the fleet of vehicles; comparing, by the processing circuit, the first fault code to a list of fault codes stored in an issue database, wherein the issue database stores a frequency value for each fault code in the list of fault codes; identifying, by the processing circuit, that the first fault code is a common fault code responsive to the frequency value of the first fault code being at or above a predetermined threshold; generating, by the processing circuit, a first group of vehicles, the first group of vehicles including one or more vehicles of the fleet of vehicles; generating, by the processing circuit, access information that causes a telematics device to log telematics data; providing, by the processing circuit, the access information to each vehicle of the first group of vehicles, the access information structured to cause each vehicle of the first group of vehicles to generate telematics data; receiving, by the processing circuit, the telematics data from one or more vehicles of the first group of vehicles; and providing the telematics data to a user device.

Another embodiment relates to a non-transitory computer readable media storing instructions that, when executed by one or more processors of a computing system, cause the computing system to perform operations. The operations include receiving access information from a remote computing system, the access information including information indicative of a data type and a logging duration; logging telematics data that corresponds to the data type, wherein logging the telematics data includes: causing one or more sensors to provide the telematics data to the computing system; storing a first set of the telematics data in a buffer for the logging duration; monitoring for a first issue; responsive to not detecting the first issue, causing the buffer to delete a portion of the first set of the telematics data; and responsive to detecting the first issue, providing the telematics data to the remote computing system.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a system for automated telematics data logging, according to an example embodiment.

FIG. 2 is a block diagram of a vehicle of the system of FIG. 1, according to an example embodiment.

FIG. 3 is a block diagram of a controller of the vehicle of FIG. 2, according to various example embodiments.

FIG. 4 is a block diagram of a telematics device of the vehicle of FIG. 2, according to an example embodiment.

FIG. 5 is a flow diagram of a method of enabling automated telematics data logging, according to an example embodiment.

FIG. 6 is a flow diagram of a method of enabling automated telematics data logging, according to another example embodiment.

FIG. 7 is a flow diagram of a method of automated telematics data logging, according to an example embodiment.

These and other features, together with the organization and manner of operation thereof, will become apparent from the following detailed description when taken in conjunction with the accompanying drawings.

### DETAILED DESCRIPTION

Following below are more detailed descriptions of various concepts related to and implementations of methods, apparatuses, and systems for automated telematics data logging. The various concepts introduced herein may be implemented in any number of ways, as the concepts described are not limited to any particular manner of implementation. Examples of specific implementations and applications are provided primarily for illustrative purposes.

Referring to the Figures generally, the various embodiments disclosed herein relate to systems, apparatuses, and methods for automated telematics data logging. A vehicle may include one or more of a propulsion system (e.g., an engine, an electric motor, or other suitable prime mover), at least one controller (e.g., an engine control module (ECM), engine control unit (ECU), other electronic control units, etc.), and/or a telematics device. In some embodiments, the telematics device is embodied as a separate hardware unit having at least one processor and at least one memory storing instructions that, when executed by the processor, cause the telematics unit to perform various operations. In some embodiments, the telematics device may be embodied in the controller as any combination of hardware and/or software. In these embodiments, the controller includes at least one processor and at least one memory storing instructions that, when executed by the processor, cause the controller and/or the telematics device thereof to perform various operations. In the embodiments described herein, the operations are described as being performed by the telematics device. However, it should be understood that the operations may be performed by the processing circuitry (e.g., processor and/or memory) of the controller in other embodiments. For example, the telematics device or parts thereof may be embodied in the controller described herein. In still other embodiments, a combination of the controller and a separate telematics device may perform various of the operations described herein in concert.

In an example operating scenario, a remote computing system uses an event triggered engineering data logger to automatically acquire telematics data. In particular, the remote computing system automatically causes a telematics device to log and transmit telematics data to the remote computing system for a fleet of vehicles. Advantageously, the remote computing system acquires a sample of telematics data from a selected group of vehicles. In another example operating scenario, a telematics device automatically logs telematics data for a single vehicle and transmits the telematics data to the remote computing system. Advantageously, the telematics device automatically performs the data logging operation prior to detecting an issue (e.g., a fault code, a diagnostic trouble code (DTC), or other diagnostic code).

In any of the example operating scenarios described above, a telematics device is configured to perform operations to log telematics data. The operations include determining a data access level. In some embodiments, the telematics device determines the data access level by requesting access level information from a remote computing system. In other embodiments, the telematics device determines the data access level based on previously received access level information. The access level refers to a quantitative or relative indication of a type of information that the telematics device may access. For example, a plurality of access levels may correspond to one or more quantitative values (e.g., between 0 and 10, between 0 and 100, etc.). In another example, the access levels include one or more relative descriptors or qualitative descriptors, such as “high”, “medium”, “low”, etc. One or more components of the vehicle, such as sensors, may have a corresponding access level. For example, a first sensor may have a first access level and a second sensor may have a second access level, different than the first access level. The telematics device is structured to acquire information, such as sensor data or other data, from one or more components of the vehicle that have an access level that is equal to or less than the determined access level.

In some embodiments, the access level defines one or more specific pieces of data or information regarding the operation of one or more specific components of the vehicle, such as a particular operational data value. Operational data generally refers to data or information regarding the operation of a vehicle or a component thereof. In these embodiments, the telematics device is structured to acquire information regarding the defined operational data value by the access level. In some embodiments, the one or more operational data values defined by the access level are defined by a user input. In other embodiments, the one or more operational data values defined by the access level are defined by the remote computing system. For example, the remote computing system may identify a common issue and determine one or more operational data values that correspond to the common issue. The remote computing system may define the one or more operational data values of the access level as the one or more operational data values that correspond to the common issue.

Beneficially, the access level limits data acquisition to optimize the type and amount of data acquired by the telematics device to data that is relevant or likely relevant to an issue. In this way, the access level reduces the amount of processing power required to acquire telematics data and reduces the amount of memory required to store the telematics data.

The operations also include logging data based on the data access level. For example, the access level may define a type of data to log. The data type may include one or more predetermined operational data values and/or one or more predetermined operational parameters of the vehicle. The operations may also include storing a predetermined amount of data in a buffer until the telematics device detects that a trigger event has occurred. For example, the telematics device may discard older data (data aged beyond a predetermined age whereby the age is based on when the data was added to the buffer) when the amount of data in the buffer exceeds the predetermined amount. Advantageously, data stored in the buffer includes operational data values corresponding to a predefined time period before the trigger event. In some embodiments, the trigger event may include detecting and/or receiving an indication of an issue (and/or determining a fault or error condition that may or may not be associated with the issue). In these embodiments, if/when the telematics device detects and/or receives an indication of an issue, the telematics device determines that the trigger event has occurred and thus may retain acquired data within the buffer and/or transmit the data within the buffer to a remote computing system. In other embodiments, trigger event includes detecting and/or receiving an indication of a first issue of a plurality of issues. In these embodiments, the access level information includes an indication of which issue of the plurality of issues is the first issue. Furthermore, if/when the telematics device detects and/or receives an indication of an issue other than the first issue defined by the access level (e.g., access information), the telematics device determines that the trigger event has not occurred. Advantageously, the telematics device may retain acquired data within the buffer without transmitting the data to a remote computing system until the trigger event occurs, thereby reducing an amount of data transmissions.

As briefly described above, the operations may also include providing the logged data to a remote computing system, responsive to detecting the trigger event. Advantageously, by discarding older data in the buffer, a data size of the logged data provided to the remote computing system is reduced. Furthermore, by waiting until a predefined trigger event is detected, the data provided to the remote computing system corresponds to data that occurred just before (a predefined amount of time before) the issue was detected such that data that is more likely the most relevant data to an issue, and this is the data that is provided to the remote computing system. Additionally, because the data stored in the buffer includes operational data values corresponding a data type defined by the access level (e.g., data that is relevant or likely relevant to the first issue), the transmitted data may include curated data of the trigger event and only when the trigger event happens. The transmission including the data within the buffer may include less than all of the generated telematics data, thereby reducing the size of the transmission, reducing the amount of processing power required to transmit the data, reducing the amount of memory to store transmitted data, and reducing costs (e.g., cellular data costs) associated with transmitting the data.

In some embodiments, the remote computing system may receive telematics data from one or more vehicles in a fleet of vehicles. As described above, the one or vehicles may provide telematics data includes data that is relevant or likely relevant to a predefined issue (e.g., the issue defined by the access level). In this way, the remote computing system receives data from one or more vehicles in the fleet that includes telematics data that is relevant or likely relevant to the predefined issue. Advantageously, a user may use the data received from the one or more vehicles to understand the issue and to troubleshoot the issue.

As used herein the term “operational parameter” and similar terms refer to a setting (numeric, etc.), an operational state, a control method or sequence, and/or other parameter that defines and/or controls operation of a piece of equipment or portion thereof (e.g., a vehicle, a vehicle engine, etc.). Examples of operational parameters may include, but are not limited to: a fuel-air mixture ratio, a transmission shift schedule, a maximum allowed engine speed, a maximum allowed engine torque, a maximum power delivery via a power take-off, a maximum engine speed, etc. The operating parameters may also include control parameters for an exhaust aftertreatment system and other component or system. As an example, control parameters for an exhaust aftertreatment system may include a dosing amount and timing, maximum/minimum allowed exhaust heater values, etc.

As used herein the term “operational data” and similar terms refer to data, information, etc. regarding operation of a piece of equipment, such as a vehicle. The operational data is based on the control parameters for the piece of equipment. The operational data may, in turn, include data regarding operation of an exhaust aftertreatment system (e.g., NOx emissions, greenhouse gas (GHG) emissions, particulate matter (PM) emissions, etc.), data regarding operation of an engine (e.g., torque, speed, etc.), data regarding operation of a turbocharger, data regarding operation of a fueling system (e.g., fuel injection timing and/or quantity), and so on. The operational data may, in some embodiments, be measured, detected, and/or determined by one or more sensors.

As used herein the term, “telematics data” and similar terms refer to any combination of operational parameters and/or operational data. In some embodiments, metadata is provided with one or both of the operational parameter(s) and/or the operational data. The metadata may include information such as a vehicle or engine identifier, a timestamp, a geo-location stamp indicative of a location of the vehicle or equipment associated with the data, and/or other metadata. Accordingly, as described herein, the operational parameter(s), operational data, and/or telematics data that is generated, transmitted, or received may additionally include corresponding metadata. For example, when an operational data value is generated, transmitted, or received, metadata corresponding to the operational data value may also be generated, transmitted, or received, respectively. More specifically, when a first operational data value is generated (e.g., detected by a sensor), the telematics device also generates metadata corresponding to the first operational data value, such as a time stamp, an identification of which sensor generated the first operational data value, a geo-location stamp, etc.

As used herein the terms “issue,” “vehicle issue,” “potential issue,” and similar terms refer to a situation where one or more vehicles and/or other equipment (e.g., powertrains, engines, etc.) or a component(s) thereof is operating of predefined set operating conditions (e.g., a threshold or other predefined conditions). In some embodiments, when a vehicle is experiencing an issue or potential issue, one or more values of the operational data of the vehicle may be greater than a maximum threshold and/or less than a minimum threshold. In some embodiments, two or more operational data values may be used in combination to characterize the issue. For example, an issue may be characterized by a first operational data value being above first threshold and a second operational data value being below a second threshold, different than the first threshold. It should be understood that any combination of operational data values (and corresponding threshold) may be used to characterize an issue. In some embodiments, the vehicle issue may correspond to a fault code or cause a triggering of a fault code or other error code, such as a diagnostic trouble code or DTC, etc. by an electronic control unit (ECU). In these embodiments, the ECU may be configured to detect and/or determine the issue and output a fault code that corresponds with the issue.

The systems, methods, and apparatuses described herein provide a technical solution to a technical problem of logging telematics data for an individual and/or fleet of vehicles and/or other equipment (e.g., powertrains, engines, etc.) that is relevant to a vehicle issue, thereby reducing the amount of data transmitted between a telematics device of a vehicle and a remote computing system. For example, in one embodiment, a telematics device may not log telematics data until a proper access level is provided to the telematics device to prevent the telematics device from logging data that is not or likely not relevant to a vehicle issue. The access level determination reduces the processing power used in creating data logs by the telematics device and reducing the memory usage of the telematics device by not storing telematics data that is not or likely not relevant to a vehicle issue. Further, when the telematics device is logging telematics data, the telematics device may filter out received data that does not or likely does not correspond to the vehicle issue. That is, substantially only data relevant to the vehicle issue is logged thereby reducing the amount of data logged by the telematics device. Additionally, the telematics device may transmit only a portion of the logged data to a remote computing system, thereby reducing the amount of data provided in a data transmission. For example, the telematics device may store the logged data in a buffer that periodically (e.g., every time new data is received, every second, every minute, every hour, etc.) deletes older logged data. Advantageously, the most recent portion of the logged data is transmitted to the remote computing system to reduce the amount of data provided in the transmission.

In an additional example embodiment, the computing systems described herein may advantageously cause a group of vehicles of a fleet of vehicles to log telematics data and provide the telematics data to the remote computing system. In this way, the remote computing system acquires a sample of telematics data from the fleet from only the group of vehicles. For example, the remote computing system may use a model (e.g., a statistical model, a machine learning model, an artificial intelligence model, etc.) to determine a first group of vehicles of a fleet. The remote computing system may cause a telematics device of each vehicle of the first group of vehicles to log and transmit telematics data to the remote computing system. Advantageously, the first group of vehicles includes fewer vehicles than the total number of vehicles in the fleet such that the amount of transmissions to receive telematics data, by the remote computing system, is reduced and the amount of data received by the remote computing system is reduced. These and other features and benefits are described more fully herein below.

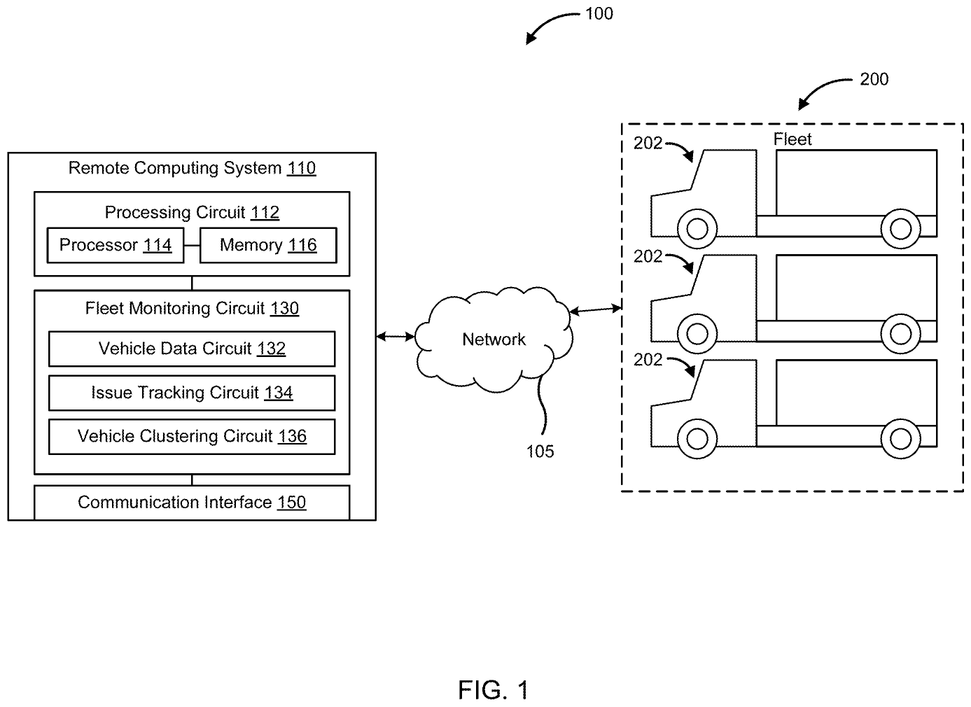

Now referring to FIG. 1, a block diagram of a system 100 for powertrain and fleet management via cloud computing is shown, according to an example embodiment. As shown in FIG. 1, the system 100 includes a network 105, a remote computing system 110 and a fleet 200 that includes one or more vehicles 202. Each of the components of the system 100 are in communication with each other and are coupled by the network 105. Specifically, the remote computing system 110 and computing systems (e.g., controllers, telematics devices, etc.) of the vehicles 202 of the fleet 200 are communicatively coupled to the network 105 such that the network 105 permits the direct or indirect exchange of data, values, instructions, messages, and the like (represented by the double-headed arrows in FIG. 1).

In some arrangements, the network 105 is configured to communicatively couple to additional computing system(s). In operation, the network 105 facilitates communication of data between the remote computing system 110 and other computing systems associated with a service provider that operates the remote computing system 110 and/or with a customer of the service provider (e.g., a vehicle or fleet owner) such as a user device (e.g., a mobile device, smartphone, desktop computer, laptop computer, tablet, or any other suitable computing system). The network 105 may include one or more of a cellular network, the Internet, Wi-Fi, Wi-Max, a proprietary provider network, a proprietary service provider network, and/or any other kind of wireless or wired network.

The remote computing system 110 is a remote computing system such as a remote server(s), a cloud computing system, and the like. As used herein, “remote computing system” and “cloud computing system” are used interchangeably to mean a computing or data processing system that has terminals distant from the central processing unit (e.g., processing circuit 112) from which users and/or other computing systems communicate with the central processing unit. In some embodiments, the remote computing system 110 is part of a larger computing system such as a multi-purpose server, or other multi-purpose computing system. In other embodiments, the remote computing system 110 is implemented on a third-party computing device operated by a third party service provider (e.g., AWS, Azure, GCP, and/or other third party computing services).

In some embodiments, the remote computing system 110 is operated by a service provider (e.g., a business). Accordingly, in some embodiments, the remote computing system 110 is a service and/or system/component provider computing system that is controlled by, managed by, or otherwise associated with service and/or system/component provider (e.g., an engine manufacturer, a vehicle manufacturer, an exhaust aftertreatment system manufacturer, etc.). In the example shown, the remote computing system 110 is operated and managed by an engine manufacturer (which may also manufacture and commercialize other goods and services). Accordingly, an employee or other operator associated with the service and/or system/component provider may operate the remote computing system 110.

As shown in FIG. 1, the remote computing system 110 includes a processing circuit 112, a fleet monitoring circuit 130, and a communications interface 150. The processing circuit 112 is coupled to the fleet monitoring circuit 130, and/or the communications interface 150.

In one configuration, the fleet monitoring circuit 130 and/or one or more of the components thereof (e.g., the vehicle data circuit 132, the issue tracking circuit 134, and/or the vehicle clustering circuit 136) are embodied as instructions that are executable by a processor, such as processor 114. The instructions may be embodied as programmable logic that includes code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the fleet monitoring circuit 130 and/or one or more of the components thereof are embodied as hardware units, such as one or more electronic control units. As such, the fleet monitoring circuit 130 and/or one or more of the components thereof may be embodied as one or more circuitry components including, but not limited to, processing circuitry, network interfaces, peripheral devices, input devices, output devices, sensors, etc. In some embodiments, the fleet monitoring circuit 130 and/or one or more of the components thereof may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the fleet monitoring circuit 130 and/or one or more of the components thereof may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The fleet monitoring circuit 130 and/or one or more of the components thereof may also include or be programmable hardware devices such as field programmable gate arrays, programmable array logic, programmable logic devices or the like. The fleet monitoring circuit 130 and/or one or more of the components thereof may include one or more memory devices for storing instructions that are executable by the processor(s) of the fleet monitoring circuit 130 and/or one or more of the components thereof. The one or more memory devices and processor(s) may have the same definition as provided below with respect to the memory device 116 and processor 114. In some hardware unit configurations, fleet monitoring circuit 130 and/or one or more of the components thereof may be geographically dispersed throughout separate locations in the system 100. Alternatively and as shown, the fleet monitoring circuit 130 and/or one or more of the components thereof may be embodied in or within a single unit/housing, which is shown as the remote computing system 110.

In the example shown, the remote computing system 110 includes the at least one processing circuit 112 having the processor 114 and the memory device 116. The processing circuit 112 may be structured or configured to execute or implement the instructions, commands, and/or control processes described herein with respect to the fleet monitoring circuit 130 and/or one or more of the components thereof. The depicted configuration represents the fleet monitoring circuit 130 and/or one or more of the components thereof being embodied as instructions. However, as mentioned above, this illustration is not meant to be limiting as the present disclosure contemplates other embodiments where the fleet monitoring circuit 130 and/or one or more of the components thereof is configured as a hardware unit. All such combinations and variations are intended to fall within the scope of the present disclosure.

The at least one processor 114 may be implemented as one or more single- or multi-chip processors, digital signal processors (DSPs), application specific integrated circuits (ASICs), field programmable gate arrays (FPGAs), and/or suitable processors (e.g., other programmable logic devices, discrete hardware components, etc. to perform the functions described herein). A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., fleet monitoring circuit 130 and/or one or more of the components thereof may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The at least one memory device 116 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 116 may include dynamic random-access memory (DRAM). The memory device 116 may be communicably connected to the processor 114 to provide computer code or instructions to the processor 114 for executing at least some of the processes described herein. Moreover, the memory device 116 may be or include tangible, non-transient volatile memory or non-volatile memory. Accordingly, the memory device 116 may include database components, object code components, script components, or any other type of information structure for supporting the various activities and information structures described herein.

The communications interface 150 is structured to receive communications from and provide communications to other computing devices, users, and the like associated with the remote computing system 110. The communications interface 150 is structured to exchange data, communications, instructions, and the like with an input/output device of the components of the system 100. In some embodiments, the communications interface 150 includes communication circuitry for facilitating the exchange of data, values, messages, etc. between the communications interface 150 and the components of the remote computing system 110. In some embodiments, the communications interface 150 includes machine-readable media storing instructions for facilitating the exchange of information between the communications interface 150 and the components of the remote computing system 110. In some arrangements, the communications interface 150 includes any combination of hardware components, communication circuitry, and machine-readable media.

The communications interface 150 may include at least one network interface. The network interface is used to establish connections with other computing devices by way of the network 105. The network interface includes program logic that facilitates connection of the remote computing system 110 to the network 105. In some arrangements, the network interface includes any combination of a wireless network transceiver (e.g., a cellular modem, a Bluetooth transceiver, a Wi-Fi transceiver) and/or a wired network transceiver (e.g., an Ethernet transceiver). For example, the communications interface 150 includes an Ethernet device such as an Ethernet card and machine-readable media such as an Ethernet driver configured to facilitate connections with the network 105. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted.

In an example embodiment, the communications interface 150 is structured to receive information from the vehicles 202 of the fleet 200 and provide the information to the components of the remote computing system 110. The communications interface 150 is also structured to transmit information (e.g., data, instructions, etc.) from the components of the remote computing system 110, such as the fleet monitoring circuit 130, to the vehicles 202 of the fleet 200.

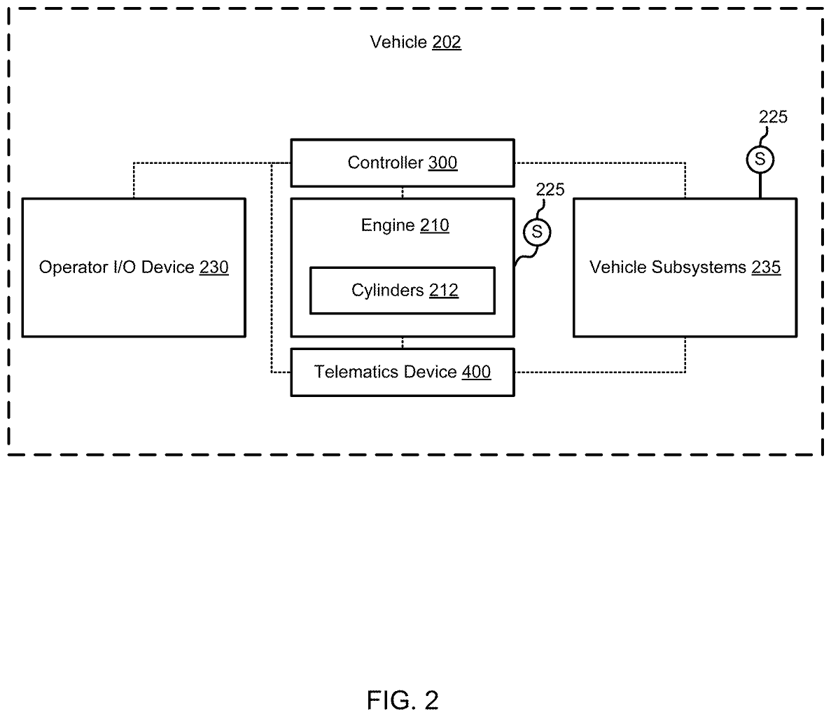

The vehicle data circuit 132 is structured to receive telematics data from one or more vehicles 202 of the fleet 200 (e.g., via the communications interface 150 and the network 105). As described above, the telematics data may include operational data and/or one or more operational parameters that correspond to a vehicle issue or potential vehicle issue. In some embodiments, the vehicle data circuit 132 is structured to provide instructions to the one or more vehicles 202 (e.g., to a controller of the vehicle) that cause the one or more vehicles 202 to provide the telematics data. For example, the vehicle data circuit 132 may be configured to provide access information to a vehicle 202. In some embodiments, the access information is provided as an access information data packet. The access information data packet is a data object that includes a payload, a header, and/or a signature. The access information may encode instructions therein that instruct, command, and/or otherwise allow and enable a telematics device (e.g., the telematics device 400 of FIG. 2) to log telematics data and transmit the telematics data to the remote computing system 110. In some embodiments the access information includes information indicative of an access level for the telematics device 400. For example, the access information may enable the telematics device 400 to log telematics data that is not normally accessible by the telematics device 400.

In some embodiments, the access information includes information indicative of a data collection parameter for the telematics device 400 to log. The data collection parameter may define a data type to be logged by the telematics device, a data logging duration, a data buffer size, etc. The data type may include one or more of engine data (e.g., engine output power, engine output torque, engine speed, engine exhaust temperature, engine exhaust pressure, etc.), aftertreatment data (e.g., an aftertreatment temperature value, aftertreatment efficiency, such as a nitrogen oxide reduction value, a carbon oxide oxidation value, a sulfur oxide reduction value, etc.), and/or other operational data or operational parameters of the vehicle 202.

In some embodiments, the data type defined by the access information may correspond to one or more issues. The issue may correspond to one or more components of the vehicle 202. The access information may define a data type that defines collecting or logging data corresponding to the one or more components of the vehicle 202. In an example implementation, a first issue may indicate a problem in a propulsion system of the vehicle 202, and the access information may define logging engine data. In another example implementation, a second issue may indicate a problem in an aftertreatment system coupled to the engine 210, and the access information may define logging engine data and aftertreatment data. It should be understood that other issues may indicate problems in other components of the vehicle 202 (e.g., the cylinders 212, the vehicle subsystems 235, and/or other components not shown in FIG. 2). Thus, the access information may define logging data corresponding to the component(s) experiencing an issue or problem.

In other embodiments, the access information may define logging one or more operational data values. In some embodiments, the remote computing system 110 may determine the one or more operational data values based on a user input. In other embodiments, the remote computing system 110 may determine the one or more operational data values based on a common issue and determining one or more operational data values that correspond to the common issue.

In some embodiments, the data logging duration may define a time period for the telematics device 400 to log data. The data logging duration may correspond with a predefined timestamp condition (e.g., data with timestamps within the last hour, the last day, the last week, etc.) that is stored by the telematics device 400. In some embodiments, the data logging duration may be defined by a predefined condition, such as detecting and/or receiving information indicative of an issue (e.g., a fault code) and/or a user device condition.

In some embodiments, the data buffer size may define a data size (e.g., megabytes, gigabytes, etc.) for the telematics device 400 to log data. The data buffer size may correspond to an amount of data (e.g., up to 100 megabytes, up to 10 gigabytes, etc.) that is stored by the telematics device. In an example implementation, the data buffer size may be 100 megabytes, and, when the amount of data stored by the buffer exceeds 100 megabytes, the telematics device 400 may delete a portion of the data stored by the buffer (e.g., starting with the oldest data).

In some embodiments, the data buffer size may define a predetermined time period or duration. For example, the data buffer size may correspond to a predetermined time period (e.g., 45 minutes, 1 hour, 1 day, etc.) that data is kept in the buffer. The telematics device 400 may automatically delete data that corresponds to older data (data aged beyond the predetermined time period whereby the age is based on when the data was added to the buffer). In an example implementation, the data buffer size may be one hour, and, when a timestamp of a data value stored by the buffer is older than one hour, the telematics device 400 may delete the data value stored by the buffer.

The issue tracking circuit 134 is structured or configured to receive data from one or more vehicles 202 of the fleet 200 relating to an issue or problem associated with the one or more vehicles 202. In this regard, the data may include an indication of an issue (e.g., a fault code). In some embodiments, the issue tracking circuit 134 is configured to determine a common issue for the fleet 200. For example, the issue tracking circuit 134 may determine that a first issue is a common issue responsive to receiving an indication of the first issue from a number of vehicles 202 of the fleet 200 that is greater than a predetermined threshold of a number of vehicles. In another example embodiment, the issue tracking circuit 134 may determine that a first issue is an issue of interest responsive to receiving a user input indicating that the first issue is of interest. In yet another example embodiment, the issue tracking circuit 134 may determine that a first issue is a common issue responsive to receiving an indication of the first issue a number of times that is greater than a predetermined threshold number of occurrences of the first issue.

In an example embodiment, the issue tracking circuit 134 is configured to determine a common issue for the fleet 200 based on determining that a number of times that a first issue has occurred is greater than a predetermined threshold. In some embodiments, the remote computing system 110 automatically enables collection of telematics data by providing access information to one or more vehicles 202 of the fleet 200. In other embodiments, the remote computing system 110 enables collection of telematics data by providing access information to one or more vehicles 202 of the fleet 200 responsive to a user input.

In some embodiments, the issue tracking circuit 134 may store or be coupled to an issue database that includes a list of issues (e.g., fault codes). The issue database may store a frequency indicator or frequency value for each of the issues in the list of issues. The frequency indicator or frequency value refers to a number of instances an issue (e.g., fault code) has occurred over a predefined time range (e.g., within the last 6 months, within the last 30 days, etc.). More specifically, the frequency indicator or frequency value indicates how often each of the issues (e.g., fault codes) has occurred based on a number of instances that the issue tracking circuit 134 has received an indication of each of the issues in the list within the predetermined time period. For example, if fault code FCXXX is received more than X times within a predefined time range (e.g., a quarter of a year) for a group of vehicles, then the issue tracking circuit 134 designates fault code FCXXX as a common fault code. If FCXXX occurs less than X times within the predefined time range, then the issue tracking circuit 134 designates fault code FCXXX as a not common fault code.

The issue tracking circuit 134 may determine that an issue is a common issue based on determining that a frequency value of the issue is greater than a frequency threshold. In some embodiments, the issue database may store information regarding whether an issue is a common issue. For example, each issue in the list of issues stored by the issue database may correspond to an indication of whether the issue is a common issue. The issue tracking circuit 134 may compare a received fault code to the issue database to determine whether the received issue is a common issue.

In some embodiments, the vehicle data circuit 132 is configured to transmit the access information to each of the vehicles 202 in the fleet 200. In other embodiments, the vehicle data circuit 132 selectively transmits the access information to one or more vehicles 202 in the fleet 200. The vehicle clustering circuit 136 is structured or configured to determine a group of vehicles 202 of the fleet 200 and enables the vehicle data circuit 132 to transmit the access information to the group of vehicles 202 of the fleet 200. In some embodiments, the group of vehicles 202 includes fewer vehicles 202 than the total amount of vehicles 202 in the fleet 200. Beneficially, when the vehicle data circuit 132 selectively transmits the access information to one or more vehicles 202 of the group, only the vehicles 202 in the group are caused to provide operational data and/or operational parameters to the remote computing system 110. In this way, the remote computing system 110 acquires a sampling of the operational data and operational parameters of the fleet 200, thereby reducing the amount of processing power required to acquire the operational data and operational parameters and reducing the amount of memory required to store the operational data and operational parameters.

The vehicle clustering circuit 136 is structured or configured to determine a group of vehicles 202 of the fleet based on one or more characteristics of the vehicles 202. In some embodiments, the vehicle clustering circuit 136 may use one or more models (e.g., statistical models, machine learning models, artificial intelligence modes, etc.) to determine the group. In some embodiments, the vehicle clustering circuit 136 determines the group based on previously received operational data and/or operational parameters. For example, the group may be determined based on vehicles 202 that have the same or similar hardware components, such as engines, aftertreatment systems, etc. In some embodiments, the vehicle clustering circuit 136 determines the group based on an engine output profile of the vehicles 202. The engine output profile includes one or more engine output values, such as an engine torque value, an engine speed value, an engine power value, etc. More specifically, the engine output profile includes an engine output value defined over a predetermined period of time and/or distance, such as a maximum engine output value during the predetermined period of time, an average engine output value over the predetermined period of time, a median engine output value over the predetermined period of time, etc. In these embodiments, the operational data may indicate that the engine output profile value of one or more vehicles 202 are similar (e.g., within 10% of each other, with 5% of each other, etc.). More specifically, the vehicles 202 of a group may have similar output torque values, similar engine speed values, and/or other similar engine output profile values. In some embodiments, the vehicles 202 of a first group may have similar output torque values, similar engine speed values, and/or other similar engine output profile values, as a first vehicle of the group of vehicles, where the first vehicle previously reported an issue. In these embodiments, the first group of vehicles may include the first vehicle.

In some embodiments, the vehicle clustering circuit 136 may group the vehicles 202 based on one or more predefined “bins.” Each bin or grouping defines a range of engine output values (e.g., a range of engine speed values, engine torque values, etc.). The vehicle clustering circuit 136 may determine a duration of time that each vehicle 202 operated with engine output values corresponding to each bin. The duration of time that each vehicle 202 operated with engine output values corresponding to each bin may be based on a cumulative number of predetermined periods of time of each engine value within a corresponding bin. For example, the vehicle clustering circuit 136 may determine that a first vehicle 202 has a first amount of engine output values within a first engine output range (e.g., a first bin) and a second amount of engine output values within a second engine output range (e.g., a second bin). The vehicle clustering circuit 136 may determine that the duration of time that first vehicle 202 operated with engine output values corresponding to the first bin is the first amount of engine output values multiplied by the duration of the predetermined period of time, and the duration of time that first vehicle 202 operated with engine output values corresponding to the second bin is the second amount of engine output values multiplied by the duration of the predetermined period of time.

The vehicle clustering circuit 136 may determine a group for a vehicle 202 based on the determined duration(s) of time. More specifically, the vehicle clustering circuit 136 may determine the group based on the largest value of the determined duration of time. For example, a first vehicle having a first duration of time value in a first bin, a second duration of time value in a second bin, and a third duration of time value in a third bin, may be grouped into a first group based on the first duration of time value being greater than the second duration of time value and greater than the third duration of time value.

In an example operating scenario, a first bin defines a first engine output range, such as a speed range between 600 rotations per minute (RPM) and 1000 RPM and a second bin defines a second engine output range, such as a speed range between 1001 RPM and 1500 RPM. The vehicle clustering circuit 136 may determine a first duration of time that a first vehicle 202 operated with engine speeds that correspond to the first bin and a second duration of time that the first vehicle 202 operated with engine speeds that correspond to the second bin, based on the telematics data received by the vehicle data circuit 132. The vehicle clustering circuit 136 may determine that the first vehicle 202 belongs to a first group, responsive to determining that the first time duration is greater than the second time duration.

In another example operating scenario, the vehicle clustering circuit 136 may receive a plurality of engine output values corresponding to each vehicle in the fleet of vehicles. Each engine output value of the plurality of engine output values corresponding to the predetermined period of time. The vehicle clustering circuit 136 may include each engine output value of the plurality of engine output values in one of a first bin corresponding to a first engine output range or a second bin corresponding to a second engine output range, different than the first engine output range, for each vehicle in the fleet of vehicles. The vehicle clustering circuit 136 may include a vehicle of the fleet of vehicles in the first group of vehicles when a first amount of the plurality of engine output values associated with the vehicle in the first bin is greater than a second amount of the plurality of engine output values associated with the vehicle in the second bin.

As shown in FIG. 1, the fleet 200 includes one or more vehicles 202. In some embodiments, the fleet 200 includes more or fewer (e.g., at least one) vehicles than as shown in FIG. 1. While shown as vehicles, in other embodiments, the fleet includes other equipment (e.g., gensets, etc.) in addition to or in place of the vehicle fleet. In yet other embodiments, the fleet 200 includes off-road equipment (e.g., power generators, mining equipment, construction equipment, marine equipment, excavation equipment, etc.).

FIG. 2 is a block diagram of a vehicle 202 of the system 100 of FIG. 1, according to an example embodiment. It should be appreciated that the description of the vehicle 202 may be applicable to any of the vehicles of the fleet 200. In this example, the vehicle 202 is an on-road and/or off-road vehicle. However, as mentioned above, in other embodiments the vehicle is a stationary piece of equipment (e.g., genset). In the example shown, the vehicle may be a passenger or commercial automobile, such as a commercial on-road vehicle including but not limited to, a line haul truck (e.g., a semi-truck, a school bus, a garbage truck, etc.); a non-commercial on-road vehicle, such as a car, truck, sport utility vehicle, cross-over vehicle, van, minivan, automobile; an off-road vehicle, such as tractor, airplane, boat, forklift, front end loader, etc.; etc.

The vehicle 202 is shown to include an engine 210, an operator I/O device, one or more vehicle subsystems 235, at least one controller 300, and a telematics device 400. In some embodiments, the vehicle 202 may include more, fewer, or different components than in the embodiment shown in FIG. 2. For example, a full electric vehicle may include more, fewer, or different sensors than an internal combustion engine vehicle. The vehicle 202 includes a sensor array that includes a plurality of sensors 225. The sensors 225 are coupled to the controller 300, such that the controller 300 can monitor, receive, and/or acquire data indicative of operation of the vehicle 202 (which may be referred to as operational data associated with the vehicle herein). In this regard, the sensor array may include one or more physical (real) or virtual sensors 225. In another example embodiment, the vehicle may include a propulsion system other than an engine. For example, the propulsion system of the vehicle may include any combination of a combustion engine, an electric motor, a battery or other electricity source, and/or other suitable prime movers. Thus, it should be understood that although certain embodiments described herein relate to an engine, any of the embodiments described herein may be applicable to any suitable propulsion system for the vehicle 202.

As shown, one or more sensors 225 are included in the vehicle 202. The number, placement, and type of sensors included in the vehicle 202 is shown for example purposes only. That is, in other configurations, the number, placement, and type of sensors may differ. For example, the sensors 225 may be located in or proximate the engine 210, upstream of the engine 210 and/or downstream of the engine 210. It should be understood that the location of the sensors may vary. The sensors 225 may be engine sensors configured to detect and/or determine one or more parameters of the engine 210 (e.g., engine operational data), such as an engine torque, an engine power, an engine speed (e.g., in rotations per minute), an engine exhaust gas value (e.g., engine exhaust manifold pressure). For example, the sensors 225 may include a torque sensor configured to detect and/or determine an engine torque, a pressure sensor configured to detect and/or determine an exhaust manifold pressure, an engine mounted accelerometer or noise sensor configured to detect and/or determine engine knock, a cylinder pressure sensor configured to detect and/or determine a pressure within a cylinder, and/or a temperature sensors configured to detect and/or determine a temperature of the engine 210, exhaust gas output by the engine, etc. Additional sensors may be also included with the vehicle 202. The sensors may include sensors associated with other components of the vehicle, such as the vehicle subsystems 235. For example, the sensors 225 may include a speed sensor of a turbo charger, a fuel quantity and injection rate sensor, a fuel rail pressure sensor, etc.).

The sensors 225 may be real or virtual (i.e., a non-physical sensor that is structured as program logic in the controller 300 and/or the telematics device 400 that makes various estimations or determinations). For example, an engine speed sensor may be a real or virtual sensor arranged to measure or otherwise acquire data, values, or information indicative of a speed of the engine 210 (typically expressed in revolutions-per-minute). The sensor 225 is coupled to the engine (when structured as a real sensor) and is structured to send a signal to the controller 300 and/or the telematics device 400 indicative of the speed of the engine 210. When structured as a virtual sensor, at least one input may be used by the controller 300 and/or the telematics device 400 in an algorithm, model, lookup table, etc. to determine or estimate a parameter of the engine (e.g., power output, etc.). Any of the sensors 225 described herein may be real or virtual.

The controller 300 and/or the telematics device 400 is/are communicably coupled to the sensors 225. Accordingly, the controller 300 and/or the telematics device 400 is/are structured to receive data from one more of the sensors 225. The received data may be used by the controller 300 to control one or more components in the system 100 and/or used by the controller 300 and/or the telematics device 400 for data logging purposes.

Any of the components of the vehicle 202 may be communicatively coupled to any other component via a direct data signal or indirectly via the controller 300 and/or the telematics device 400. For example, the data signals (shown as dashed lines in FIG. 2) are structured to pass through one or more components such as the controller 300 and/or the telematics device 400.

In some embodiments, the engine 210 is an internal combustion engine (ICE) such as a spark ignition (S.I.) engine or a compression ignition (C.I.) engine. Accordingly, the engine 210 includes one or more cylinders 212. The engine 210 is structured to provide mechanical energy to power the vehicle 202. For example, the engine 210 is structured to consume a fuel (e.g., gasoline, diesel, natural gas, hydrogen, etc.) to generate power.

In other embodiments, the vehicle 202 includes an electric machine such as an electric motor, a fuel cell engine, etc. As such, the vehicle may be a hybrid vehicle (e.g., a parallel or series hybrid, a full electric vehicle, a plug-in hybrid vehicle, etc.), a fuel cell powered vehicle, and so on. The vehicle may also include a battery (not shown) for powering the electric motive device/machine. When the vehicle includes an electric motor, the electric motor(s) may generate electric power from one or more electrical energy storage devices (e.g., one or more batteries that may be charged with electric power, a hydrogen source for fuel cell applications, etc.).

The operator I/O device 230 may be coupled to the controller 300, such that information may be exchanged between the controller 300 and the I/O device 230, wherein the information may relate to one or more components of FIG. 1 or determinations (described below) of the controller 300. The operator I/O device 230 enables an operator of the vehicle 202 to communicate with the controller 300 and one or more components of the vehicle 202. For example, the operator input/output device 230 may include, but is not limited to, an interactive display, a touchscreen device, one or more buttons and switches, voice command receivers, etc. In this way, the operator input/output device 230 may provide one or more indications or notifications to an operator, such as a malfunction indicator lamp (MIL), etc. Additionally, the vehicle may include a port that enables the controller 300 to connect or couple to a scan tool so that indications of issues (e.g., fault codes) and other information regarding the vehicle may be obtained.

The vehicle subsystems 235 may include one or more components, systems, and/or devices included with the vehicle, such as mechanically driven or electrically driven vehicle components. The vehicle subsystems 235 may include, but are not limited to, an HVAC system, lights, pumps, fans, and so on.

In some embodiments, the vehicle subsystems 235 also include one or more components positioned downstream of the engine 210 and configured to receive exhaust output by the engine 210. In some embodiments, the vehicle 202 includes a turbocharger configured to receive exhaust output by the engine 210 and compress intake fluid (e.g., air, etc.) provided to the engine 210. In some embodiments, the vehicle 202 includes an aftertreatment system having components used to convert exhaust emissions, such as selective catalytic reduction (SCR) catalyst, a diesel oxidation catalyst (DOC), a diesel particulate filter (DPF), a diesel exhaust fluid (DEF) doser with a supply of diesel exhaust fluid, a plurality of sensors for monitoring the aftertreatment system (e.g., a nitrogen oxide (NOx) sensor, temperature sensors, etc.), and/or still other components.

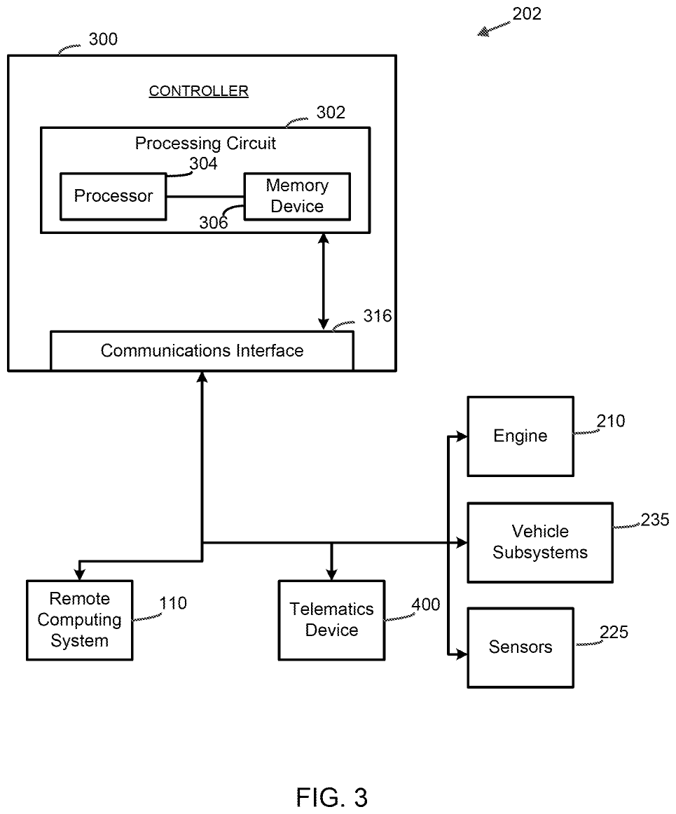

As shown in FIG. 2, the controller 300 is operatively and communicatively coupled to various components of the vehicle 202. The controller 300 is structured to control the operation, at least partly of each of the components of the vehicle 202 by providing one or more commands to the components. For example, the controller 300 is structured to change an operational parameter of the engine 210, the operator I/O device, and/or the vehicle subsystems 235. The controller 300 is also structured to receive information, such as data signals, from various components and/or systems of the vehicle 202. For example, the controller 300 can receive data from the sensors 225. The controller 300 is described in further detail herein below with respect to FIG. 3.

The vehicle 202 is shown to include a telematics unit or device 400. The telematics device 400 may be structured as any type of telematics control unit. Accordingly, the telematics device 400 may include, but is not limited to, a location positioning system (e.g., global positioning system) to track the location of the vehicle (e.g., latitude and longitude data, elevation data, etc.), one or more memory devices for storing the tracked data, one or more electronic processing units for processing the tracked data, and a communications interface for facilitating the exchange of data between the telematics device 400 and one or more remote devices (e.g., a provider/manufacturer of the telematics device, etc.). In this regard, the communications interface may be configured as any type of mobile communications interface or protocol including, but not limited to, Wi-Fi, WiMax, Internet, Radio, Bluetooth, Zigbee, satellite, radio, Cellular, GSM, GPRS, LTE, and the like. The telematics device 400 may also include a communications interface for communicating with the controller 300 of the vehicle 202. The communication interface for communicating with the controller 300 may include any type and number of wired and wireless protocols (e.g., any standard under IEEE 802, etc.). For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information, and/or data between the controller 300 and the telematics device 400. In other embodiments, a local area network (LAN), a wide area network (WAN), or an external computer (for example, through the Internet using an Internet Service Provider) may provide, facilitate, and support communication between the telematics device 400 and the controller 300. In still another embodiment, the communication between the telematics device 400 and the controller 300 is via the unified diagnostic services (UDS) protocol. All such variations are intended to fall within the spirit and scope of the present disclosure.

Now referring to FIG. 3, a schematic diagram of the controller 300 of the vehicle 202 of FIG. 2 is shown according to various example embodiments. As shown in FIG. 3, the controller 300 includes a processing circuit 302 having a processor 304 and a memory device 306, and a communications interface 316. As described herein, the controller 300 is structured to control the operation of the vehicle 202 and/or one or more components thereof (e.g., the engine 210, the sensors 225, the vehicle subsystems 235, etc.).

In some embodiments, the telematics device 400 is included in the controller 300. More specifically, the telematics device 400 may be embodied as any combination of hardware and/or software in the controller 300. In other embodiments and as shown in FIG. 3, the telematics device 400 is separate from the controller 300 and may be communicatively coupled to the controller 300.

The at least one processing circuit 302 includes at least one processor 304 coupled to at least one memory device 306. The processing circuit 302 may be structured or configured to execute or implement the instructions, commands, and/or control processes described herein with respect to the telematics device 400.

The at least one processor 304 may be implemented as one or more single- or multi-chip (including chiplet designs) processors, digital signal processors (DSPs), application specific integrated circuits (ASICs), field programmable gate arrays (FPGAs), and/or suitable processors (e.g., other programmable logic devices, discrete hardware components, etc. to perform at least some of the functions described herein). A processor may be a microprocessor, a group of processors, etc. A processor also may be implemented as a combination of computing devices, such as a plurality of microprocessors or other suitable combination of hardware components. In some embodiments, the one or more processors may be shared by multiple circuits. Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The at least one memory device 306 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 306 may include dynamic random-access memory (DRAM). The memory device 306 may be communicably connected to the processor 304 to provide computer code or instructions to the processor 304 for executing at least some of the processes described herein. Moreover, the memory device 306 may be or include tangible, non-transient volatile memory or non-volatile memory. Accordingly, the memory device 306 may include database components, object code components, script components, or any other type of information structure for supporting the various activities and information structures described herein.

The communications interface 316 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle 202) and out-of-vehicle communications (e.g., with the remote computing system 110). For example and regarding out-of-vehicle/system communications, the communications interface 316 may include an Ethernet card and port for sending and receiving data via an Ethernet-based communications network and/or a Wi-Fi transceiver for communicating via a wireless communications network. The communications interface 316 may be structured to communicate via local area networks or wide area networks (e.g., the Internet) and may use a variety of communications protocols (e.g., IP, LON, Bluetooth, ZigBee, radio, cellular, near field communication).

As shown, the communications interface 316 may enable communication with the remote computing system 110 (e.g., via the network 105), the telematics device 400, and/or one or more components of the vehicle 202, such as the engine 210, the sensors 225, and/or the vehicle subsystems 235. In some embodiments, the communications interface 316 does not enable direction communication with the remote computing system 110 and instead, the controller 300 communicates with the remote computing system 110 via the telematics device 400.

In some embodiments, the controller 300 is structured to control the operation of the sensors 225 and exchange information with the sensors 225. For example, the controller 300 may be structured to generate one or more control signals and transmit the control signals to one or more sensors 225 (e.g., to acquire data, etc.). The control signals may cause the one or more sensors 225 to sense and/or detect operational data and/or provide the operational data to the controller 300. In some embodiments, the controller 300 may be structured to estimate the sensor data (e.g., when the sensors 225 are virtual sensors). The operational data may include temperature data (e.g., fluid temperature such as exhaust gas temperature or engine oil temperature, component temperature such as engine temperature, etc.), flow rate data (e.g., exhaust gas flow rate data, charge air flow rate, etc.), pressure data (e.g., engine cylinder pressure, coolant pressure, exhaust gas pressure, etc.), engine operational data (e.g., engine torque, engine speed, engine power, etc.), and/or other data related to the operation of the vehicle 202.

In some embodiments, the controller 300 is, includes, or is part of a vehicle control unit, such as an engine control module (ECM), an engine control unit (ECU), or other electronic control unit structured to control one or more components of the vehicle 202. In these embodiments, the controller 300 is configured to acquire data (e.g., via the sensors 225) corresponding to one or more components of the vehicle 202, such as the engine 210, the vehicle subsystems 235, etc., and output an indication of an issue (e.g., a fault code) for the one or more components based on the data. For example, the controller 300 may use a lookup table that correlates operational data and/or operational parameters to one or more issues. Responsive to determining that the operational data and/or operational parameters corresponds to an issue, the controller 300 may output an indication of the issue (e.g., via the communications interface 316). In some embodiments, the controller 300 provides the indication of the issue to the remote computing system 110 and/or the telematics device 400.

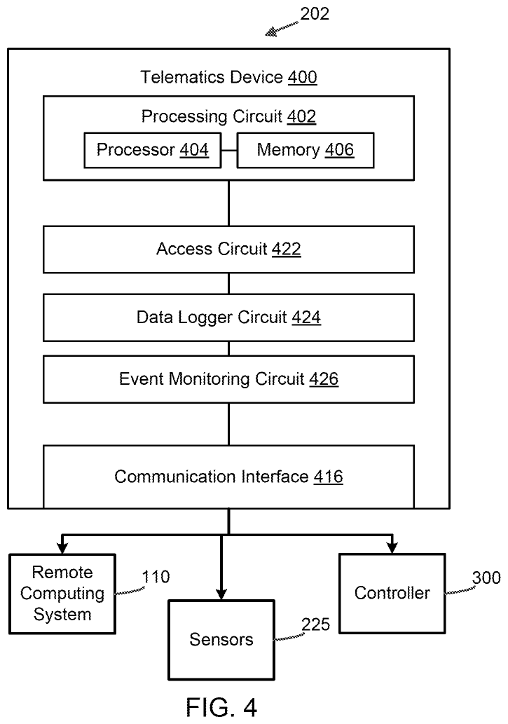

Now referring to FIG. 4, a schematic diagram of the telematics device 400 of the vehicle 202 of FIG. 2 is shown according to an example embodiment. As shown in FIG. 4, the telematics device 400 includes a processing circuit 402 having a processor 404 and a memory device 406, an access circuit 422, a data logger circuit 424, an event monitoring circuit 426, and a communications interface 416. As described herein, the telematics device 400 is structured to log data regarding the operation of the vehicle 202 and/or one or more components thereof (e.g., the engine 210, the sensors 225, the vehicle subsystems 235, etc.). As described in greater detail herein, in some embodiments, the buffer may be part of the memory device 406.

In some embodiments, the access circuit 422, the data logger circuit 424, and/or the event monitoring circuit 426 are embodied as any combination of hardware and/or software. For example, the access circuit 422, the data logger circuit 424, and/or the event monitoring circuit 426 may be embodied as hardware, software, and/or any combination thereof, such as machine or computer-readable media storing instructions.

The processing circuit 402 includes the processor 404 and the memory device 406. The processing circuit 402 may be structured or configured to execute or implement the instructions, commands, and/or control processes described herein with respect to the access circuit 422, the data logger circuit 424, and/or the event monitoring circuit 426. The depicted configuration represents the access circuit 422, the data logger circuit 424, and/or the event monitoring circuit 426 being embodied as machine or computer-readable media storing instructions. However, as mentioned above, this illustration is not meant to be limiting as the present disclosure contemplates other embodiments where the access circuit 422, the data logger circuit 424, and/or the event monitoring circuit 426 is configured as a hardware unit. All such combinations and variations are intended to fall within the scope of the present disclosure.

The at least one processor 404 may be implemented as one or more single-chip, multi-chip, and/or chiplet processors, digital signal processors (DSPs), application specific integrated circuits (ASICs), field programmable gate arrays (FPGAs), and/or suitable processors (e.g., other programmable logic devices, discrete hardware components, etc. to perform the functions described herein). A processor may be a microprocessor, a group of processors, etc. A processor also may be implemented as a combination of computing devices, such as a plurality of microprocessors or other suitable combination of hardware components. In some embodiments, the one or more processors may be shared by multiple circuits (e.g., the access circuit 422, the data logger circuit 424, and/or the event monitoring circuit 426 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The at least one memory device 406 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 406 may include dynamic random-access memory (DRAM). The memory device 406 may be communicably connected to the processor 404 to provide computer code or instructions to the processor 404 for executing at least some of the processes described herein. Moreover, the memory device 406 may be or include tangible, non-transient volatile memory or non-volatile memory. Accordingly, the memory device 406 may include database components, object code components, script components, or any other type of information structure for supporting the various activities and information structures described herein.

The communications interface 416 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle 202) and out-of-vehicle communications (e.g., with the remote computing system 110). For example and regarding out-of-vehicle/system communications, the communications interface 416 may include an Ethernet card and port for sending and receiving data via an Ethernet-based communications network and/or a Wi-Fi transceiver for communicating via a wireless communications network. The communications interface 416 may be structured to communicate via local area networks or wide area networks (e.g., the Internet) and may use a variety of communications protocols (e.g., IP, LON, Bluetooth, ZigBee, radio, cellular, near field communication).

As shown, the communications interface 416 may enable communication with the remote computing system 110 (e.g., via the network 105), the controller 300, and/or one or more components of the vehicle 202, such as the sensors 225. In some embodiments, the communications interface 416 enables communication between the controller 300 and the remote computing system 110.

In some embodiments, the telematics device 400 is structured to control the operation of the sensors 225 and exchange information with the sensors 225. For example, the telematics device 400 may be structured to generate one or more control signals and transmit the control signals to one or more sensors 225 (e.g., to acquire data, etc.). The control signals may cause the one or more sensors 225 to sense and/or detect the operational data and/or provide the operational data to the telematics device 400. In some embodiments, the telematics device 400 may be structured to estimate the operational data (e.g., when the sensors 225 are virtual sensors).

The access circuit 422 is structured to receive the access information from the remote computing system 110 (e.g., via the network 105 and/or the communication interface 416). In some embodiments, the access circuit 422 is configured to determine an access level based on the access information. As described above, the access information may define the access level. For example, responsive to determining the access level, the access circuit 422 may determine that the telematics device 400 may receive information (e.g., operational data, operational parameters, etc.) from a predefined group of one or more sensors and/or a predefined group of one or more components of the vehicle 202. Beneficially, the access level limits data acquisition to optimize the type and amount of data acquired by the telematics device 400 thereby reducing the amount of processing power required to acquire the data and reducing the amount of memory required to store the data. Further, as described herein, the access level further defines a type of data to acquire that corresponds to a particular issue, such as a fault code, such that the data acquired by the telematics device 400 is relevant or is likely only relevant to the particular issue.

In some embodiments, the access circuit 422 may not receive an access information from the remote computing system. In these embodiments, when the access circuit 422 attempts to determine the access level, the access circuit 422 may determine that the access level is not known. In some embodiments, when the access circuit 422 has not received an access information from the remote computing system, the access circuit 422 may send a request for access information to the remote computing system 110. In some embodiments, when the access circuit 422 cannot determine the access level, the access circuit 422 advantageously prevents the telematics device 400 from acquiring and/or logging data, thereby reducing the amount of processing power to acquire data and reducing the amount of memory used to store logged data.

The data logger circuit 424 is structured to log data received by the telematics device 400. In some embodiments, the data logger circuit 424 is structured to selectively log data that corresponds to one or more vehicle issues (e.g., one or more fault codes).

In some embodiments, the data logger circuit 424 is structured to store logged data in a buffer. In some embodiments, the buffer may be part of the memory device 406. In other embodiments, the buffer may be a separate memory device, and in some implementations the buffer memory device may be a memory device of the data logger circuit 424. As described above, the buffer may store the logged data for a predetermined time period (e.g., 1 hour, 1 day, etc.) and/or based on a predetermined file size (e.g., in megabytes or gigabytes, etc.).

The event monitoring circuit 426 is structured to receive an indication of a triggering event, such as an issue or other predefined condition (e.g., an issue as described herein) from the controller 300. As described above, responsive to detecting a vehicle issue (e.g., via the sensors 225) the controller 300 may trigger and output an indication of an issue. The event monitoring circuit 426 is structured to receive the indication of the issue. In some embodiments, the event monitoring circuit 426 is structured to provide the logged data (e.g., data stored in the buffer) to the remote computing system 110 (e.g., via the network 105 and/or the communication interface 416) responsive to receiving the indication of the issue.

In some embodiments, the triggering event corresponds to receiving a particular issue or particular issues of a plurality of issues. In these embodiments, the access information includes information indicating one or more issues of the plurality of issues is/are the particular issue(s). The event monitoring circuit 426 is structured to receive any indication of an issue that is output by the controller 300 and to compare the received indication of the issue to the one or more issues indicated by the access information or, more specifically, to one or more vehicle issues that are associated with one or more fault codes. Responsive to determining that the received issue is the same as the one or more issues indicated by the access information, the event monitoring circuit 426 may provide the logged data to the remote computing system 110. Responsive to determining that the receive issue is not in the predetermined list, the event monitoring circuit 426 may not provide the logged data to the remote computing system 110 such that data that is likely not relevant (i.e., a basis or cause of the issue) to the one or more issues indicated by the access information is not transmitted to the remote computing system 110.

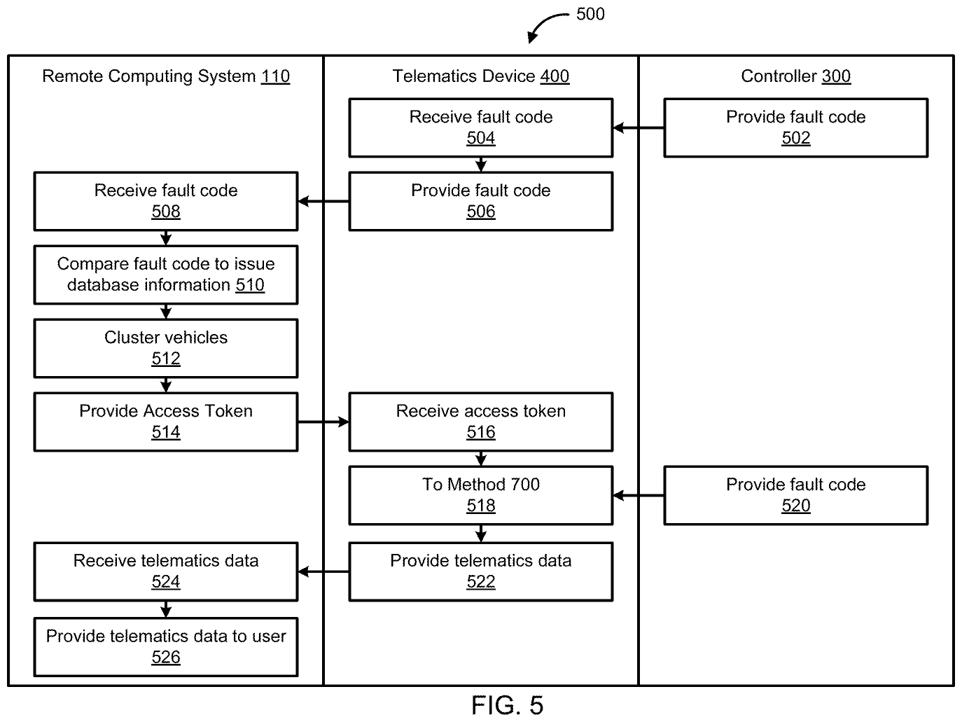

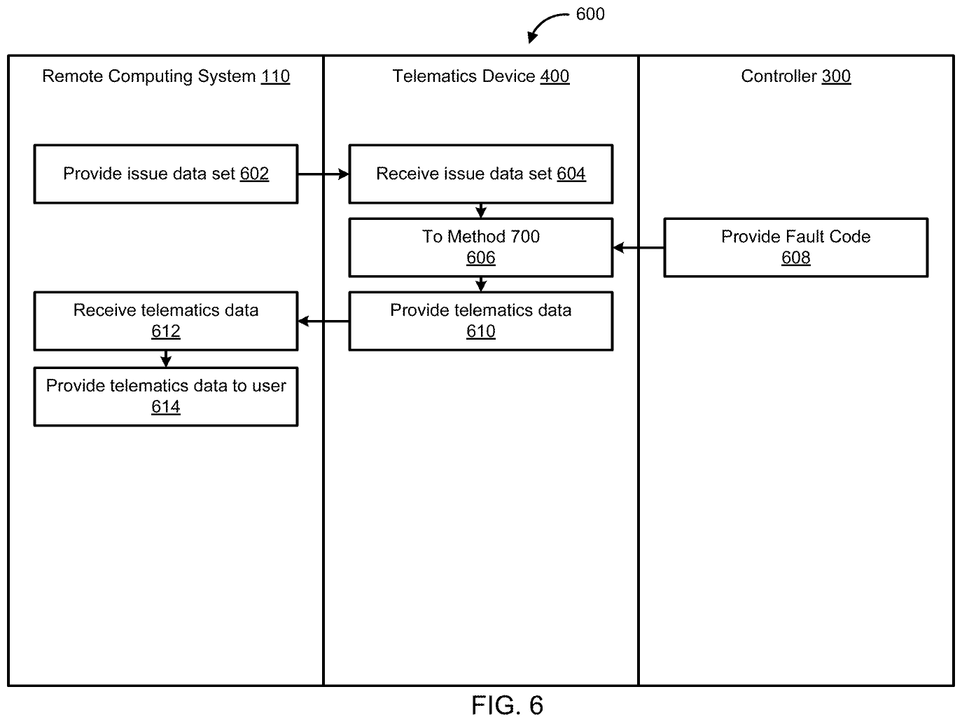

Referring now to FIGS. 5-6, methods of logging data are shown, according to various example embodiments. In particular, the method 500 shown in FIG. 5 relates to an automated telematics data logging operation for a fleet 200 of vehicles 202. Advantageously, the remote computing system 110 acquires telematics data from a selected group of vehicles 202. The method 600 shown in FIG. 6 relates to an automated telematics data logging operation for a single vehicle 202. Advantageously, the telematics device 400 automatically performs the data logging operation responsive to detecting an issue (e.g., a fault code) that corresponds to a common issue.

FIG. 5 is a flow diagram of a method 500 of enabling automated telematics data logging, according to an example embodiment. As shown in FIG. 5, the method 500 may be performed by any combination of the remote computing system 110, the telematics device 400, and/or the controller 300. In some embodiments, when the telematics device 400 or parts thereof is embodied in the controller 300, the steps shown as being performed by the telematics device 400 are performed by the controller 300. The method 500 relates to a cloud-based method of logging data from one or more vehicles 202 of the fleet 200. In some embodiments, the processes of the method 500 may be performed in a different order than as shown in FIG. 5. In some embodiments, the method 500 may include more or fewer processes than as shown in FIG. 5. In some embodiments, the processes of the method 500 may be performed concurrently, partially concurrently, or sequentially. It should be understood that, although the method 500 relates to a single vehicle 202 of the fleet 200, the method 500 may be performed by any number of vehicles 202 of the fleet 200.

At process 502, the controller 300 detects a vehicle issue and provides an indication of the issue to the telematics device. In one embodiment, the indication of the issue is embodied as a fault code (or, diagnostic trouble code, error code, etc.). In the explanation of this method, the indication is described as the fault code. However, it should be understood that in other embodiments, different indications as described herein may be utilized (e.g., operating conditions not complying with one or more desired operating ranges/values/thresholds/etc.).

At process 504, the telematics device 400 receives the fault code. At process 506, the telematics device 400 provides an indication of the vehicle issue, as defined by the fault code, to the remote computing system 110. At process 508, the remote computing system 110 receives the fault code. In some embodiments, at process 508, the remote computing system may receive the fault code from one or more vehicles 202 of the fleet 200. For example, the remote computing system 110 may receive the fault code from at least a first vehicle of the fleet 200.

At process 510, the remote computing system 110 compares the received fault code to information stored in the issue database. The remote computing system 110 may determine based on comparing the fault code to information stored in the issue database, whether the fault code is a common fault code. For example, the issue database may store a frequency value for each fault code of a plurality of fault codes. Responsive to determining that the frequency value of the received fault code is greater than a predetermined threshold frequency value, the remote computing system 110 may determine that the received fault code is a common fault code. As described herein, the granularity of determining the frequency may be further limited by characteristics surrounding the fault code, such as: based on vehicle type, engine type (e.g., certain engine models), specific to a fleet irrespective of the engine or vehicle types included therein, and so on.

At process 512, the remote computing system 110 is configured to cluster one or more vehicles 202 of the fleet 200. More specifically, the remote computing system 110 is configured to determine a group of one or more vehicles 202 and to acquire telematics data from the group of vehicles 202 such that the remote computing system 110 acquires a sample of the telematics data form the fleet 200. As described above, the remote computing system 110 may use one or more models (e.g., statistical models, machine learning models, etc.) to cluster the one or more vehicles 202. Advantageously, by only acquiring a sample of the telematics data, the amount of processing power and memory required to receive and store the telematics data is reduced. In some embodiments, the process 512 is performed responsive to determining that the received fault code is a common fault code at process 514.

At process 514, the remote computing system 110 generates and provides access information to the telematics device 400. As described above, the access information may define an access level for the telematics device 400. In some embodiments, the access information may also indicate a type of data for the telematics device 400 to log. For example, the access information may define one or more vehicle issues (and/or corresponding fault codes) that correspond to a particular data type for the telematics device 400 to log. In some embodiments, the access information may also indicate a type of event for the telematics device 400 to monitor. For example, the access information may define one or more fault codes that for the telematics device 400 to monitor.

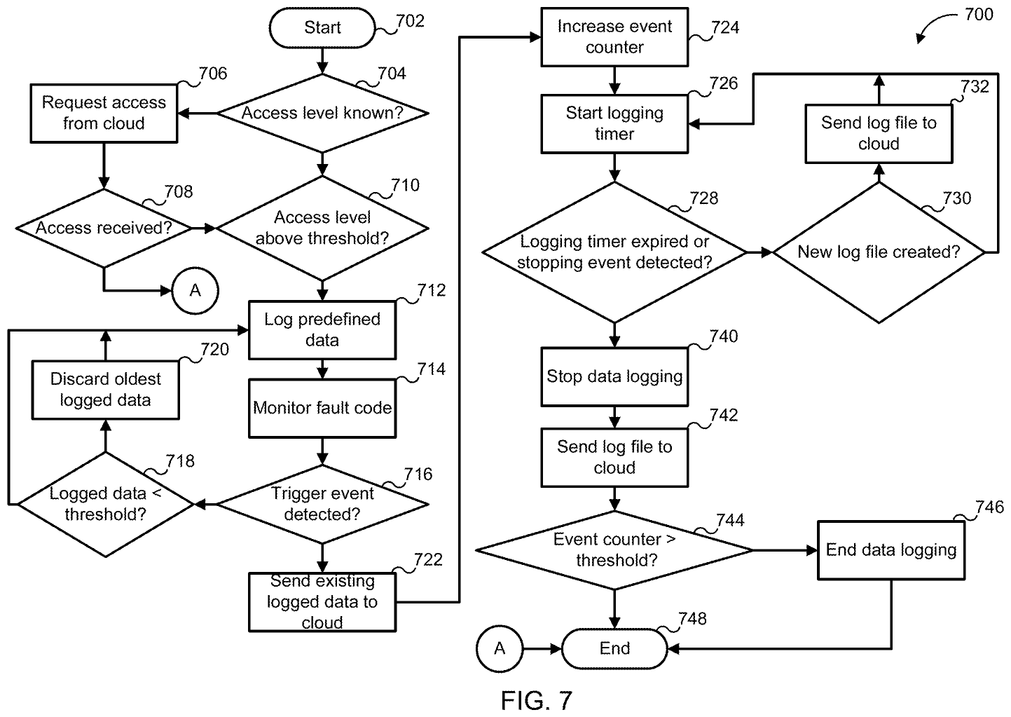

At process 516, the telematics device 400 receives the access information. At process 518, the telematics device 400 performs the method 700, described herein with respect to FIG. 7. At process 520, controller 300 provides a fault code to the telematics device 400. At process 522, the telematics device provides telematics data to the remote computing system 110. In some embodiments, process 514, process 516, process 520, and/or process 522 may be performed as part of the method 700.

At process 524, the remote computing system 110 receives telematics data from the remote computing system 110. At process 526, the remote computing system 110 provides the telematics data to a user device, such as a personal computer, laptop, smartphone, etc.

FIG. 6 is a flow diagram of a method of enabling automated telematics data logging, according to another example embodiment. As shown in FIG. 6, the method 600 may be performed by any combination of the remote computing system 110, the telematics device 400, and/or the controller 300. In some embodiments, when the telematics device 400 is embodied in or parts thereof in the controller 300, the steps shown as being performed by the telematics device 400 are performed by the controller 300. The method 600 relates to a local method of logging data corresponding to a vehicle 202 of the fleet 200. In some embodiments, the processes of the method 600 may be performed in a different order than as shown in FIG. 6. In some embodiments, the method 600 may include more or fewer processes than as shown in FIG. 6. In some embodiments, the processes of the method 600 may be performed concurrently, partially concurrently, or sequentially. Similar to the description of the method 500, as described herein, the indication of the issue is embodied as a fault code (or, diagnostic trouble code, error code, etc.). In the explanation of this method, the indication is described as the fault code. However, it should be understood that in other embodiments, different indications as described herein may be utilized (e.g., operating conditions not complying with one or more desired operating ranges/values/thresholds/etc.).

At process 602, the remote computing system 110 provides an issue data set to the telematics device. The issue data set may include the same or similar information as the information stored in the issue database associated with the issue tracking circuit 134 (or a subset thereof). For example, the issue data set may include a list of issues and corresponding fault codes, a list of fault codes, and/or a frequency value for each of the fault codes. At process 604, the telematics device 400 receives the issue data set.

At process 606, the telematics device 400 performs the method 700, described herein with respect to FIG. 7. At process 608, the controller 300 provides a fault code to the telematics device 400. At process 610 the telematics device 400 provides telematics data to the remote computing system 110. In some embodiments, process 608 and/or process 610 may be performed as part of the method 700.

At process 612, the remote computing system 110 receives telematics data from the remote computing system 110. At process 614, the remote computing system 110 provides the telematics data to a user device, such as a personal computer, laptop, smartphone, etc.

FIG. 7 is a flow diagram of a method 700 of automated telematics data logging, according to an example embodiment. In the embodiment shown in FIG. 7, the method 700 may be performed by the telematics device 400. In some embodiments, when the telematics device 400 is embodied in the controller 300, the method 700 may be performed by the controller 300. In some embodiments, the processes of the method 700 may be performed in a different order than as shown in FIG. 7. In some embodiments, the method 700 may include more or fewer processes than as shown in FIG. 7. In some embodiments, the processes of the method 700 may be performed concurrently, partially concurrently, or sequentially. Similar to the description of the method 500, as described herein, the indication of the issue is embodied as a fault code (or, diagnostic trouble code, error code, etc.). In the explanation of this method, the indication is described as the fault code. However, it should be understood that in other embodiments, different indications as described herein may be utilized (e.g., operating conditions not complying with one or more desired operating ranges/values/thresholds/etc.).

At process 702, an enable condition is received. The enable condition refers to a control signal received by the telematics device 400 and/or a predefined condition detected and/or determined by the telematics device 400. In this way, the telematics device 400 begins the method 700 when the enable condition is satisfied. In some embodiments, the predefined condition includes a power on event of the telematics device. More specifically, the enable condition is satisfied when the telematics device detects that the telematics device 400 has been powered on. In other embodiments, the enable condition is satisfied when the telematics device 400 receives a control signal from the controller 300 and/or the remote computing system 110. In some embodiments, the predefined condition is the enable condition. That is, when the predefined condition is detected and/or determined by the telematics device 400, the enable condition is satisfied.

At process 704 the telematics device 400 determines whether access information is stored by the telematics device 400 (e.g., the memory device 406). Responsive to determining that the access information is sorted by the telematics device 400 the telematics device determines an access level based on the stored access information. Responsive to determining the access level, the method 700 continues to process 710. Responsive to determining that the access information is not sorted by the telematics device 400, the method 700 continues to process 706.

At process 706, the telematics device 400 requests access information from the remote computing system 110 (e.g., the “cloud”). In some embodiments, the remote computing system 110 provides the access information to the telematics device 400 automatically (e.g., without a request from the telematics device 400). In some embodiments, the remote computing system 110 may provide the access information to the telematics device 400 responsive to determining that the telematics device 400 is onboard a first vehicle of a group of vehicles determined by the vehicle clustering circuit 136 (e.g., as process 512 of FIG. 5).

At process 708, the telematics device 400 determines whether access information has been received from the remote computing system 110. Responsive to determining that the access information has not been received, the method 700 continues to process 748 (as shown by element “A”). Responsive to determining that the access information has been received, the method 700 continues to process 710.

At process 710, the telematics device 400 determines whether an access level defined by the access information is above a threshold access level (e.g., an “access threshold”). In some embodiments, the access level includes a plurality of access levels that are defined by one or more quantitative values (e.g., between 0 and 10, between 0 and 100, etc.), and the threshold access level is a predefined value (e.g., 8, 80, etc.). In other embodiments, the access levels include one or more relative descriptors or qualitative descriptors, such as “high,” “medium,” “low,” etc., and the threshold access level is a predefined relative descriptor, such as medium. In any of the above-described embodiments, one or more components of the vehicle 202, such as the sensors 225, have a corresponding access level. The access level determined by the telematics device 400 enables the telematics device 400 to acquire data from sensors 225 and/or other components of the vehicle 202 that have corresponding access levels that are equal to or less than the determined access level. Beneficially, the access level limits data acquisition to optimize the type and amount of data acquired by the telematics device 400 to data that is relevant or likely relevant to a fault code, such as the fault code indicated by the access information. In this way, the access level reduces the amount of processing power required to acquire telematics data and reduces the amount of memory required to store the telematics data. For example, the access level may be a high access level and the threshold access level may be a medium access level. The telematics device 400 may determine that, because the access level is relatively higher than the “medium” access level threshold, the access level defined by the access information is above the threshold access level. In an example embodiment, the access level defined by the access information may indicate that the telematics device 400 may acquire data from sensors 225 and/or other components of the vehicle 202 that have corresponding access levels that are equal to or less than the threshold access level and/or the determined access level. The telematics device 400 may not acquire data from sensors 225 and/or other components of the vehicle 202 that have corresponding access levels that are above the threshold access level and/or the determined access level.

In some embodiments, at process 710, the telematics device 400 determines a type of data to access based on the access information. As described above, the access information may define one or more data collection parameters, such as a data type. In some embodiments, the data type defined by the access information may correspond to one or more fault codes. For example, the access information may define a fault code that corresponds to a type of data.

At process 712, the telematics device 400 begins logging data. In some embodiments, the logged data corresponds to the data type determined at process 710. For example, the telematics device 400 may log data that corresponds to a fault code indicated by the access information such that data that likely does not correspond to the fault code indicated by the access information is not logged, thereby reducing the processing power and memory usage of the telematics device 400. In some embodiments, the logged data is a set of the telematics data (e.g., a first set of the telematics data). The telematics device 400 may discard (or not log) another set of the telematics data (e.g., a second set of the telematics data) that does not correspond to the fault code. In some embodiments, the logged data is stored in the buffer (e.g., the memory device 306 and/or the memory device 406). Advantageously, the logged data is stored in the buffer before a triggering event occurs such that the logged data corresponds to data that occurred just before (a predefined amount of time before, such as 45 minutes, 1 hour, etc.) the trigger event (e.g., an issue occurring) occurred such that data that is more likely the most relevant data to an issue.

At process 714, the telematics device 400 monitors for a fault code. As described above, the telematics devices may monitor the controller 300 for one or more particular fault codes of a plurality of fault codes. The access information includes information indicating one or more fault codes of the plurality of fault codes is/are the particular fault code(s). The telematics device 400 monitors the controller 300 for the one or more particular fault codes by comparing a fault code received from the controller 300 to a list of one or more fault codes indicated by the access information.

At process 716, the telematics device 400 determines whether a fault code has been detected or received from the controller 300 and/or an electronic control unit. Responsive to not detecting or receiving the particular fault code indicated by the access information, the method 700 may continue to process 718. Responsive to detecting or receiving the particular fault code indicated by the access information, the method 700 may continue to process 722.

At process 718, the telematics device 400 compares the data logged at process 712 to a threshold. In some embodiments, the threshold may be a file size threshold measured in megabytes, gigabytes, etc. In other embodiments, the threshold may be a timestamp threshold (e.g., 1 hour, 1 day, 1 week, etc.). Responsive to determining that the logged data is greater than the file size threshold and/or determining that the logged data includes timestamps that are greater than the timestamp threshold, the method 700 may continue to process 720. Responsive to determining that the logged data is less than or equal to the file size threshold and/or determining that the logged data includes timestamps that are less than or equal to the timestamp threshold, the method 700 may continue to process 712.

At process 720, the telematics device 400 deletes the oldest data until the logged data is below the threshold. For example, the telematics device 400 may delete logged data that corresponds to the oldest timestamps until the file size of the logged data is below the file size threshold. In another example, the telematics device 400 may delete logged data that corresponds to the oldest timestamps until the oldest logged data has a corresponding timestamp that is less than or equal to the timestamp threshold.

At process 722, the telematics device 400 sends the existing logged data to the remote computing system 110. Beneficially, the logged data may include data that corresponds to or likely corresponds to the fault code and data that is within a threshold time period (e.g., less than or equal to the threshold timestamp) and/or within a threshold file size (e.g., less than or equal to the file size threshold), such that the amount of processing power, memory, and/or bandwidth required to transmit the logged data to the remote computing system 110 is reduced.

At process 724, the telematics device 400 increases an event counter. The event counter indicates a number of times the fault code has been received and/or detected by the telematics device 400 at process 716. In some embodiments, the telematics device selectively increases the event counter responsive to determining that the received fault code is the same as the fault code indicated by the access information.

At process 726, the telematics device 400 starts a timer (e.g., a data logging timer). In some embodiments, the timer refers to a software-based time measurement tool that counts up to or down from a predetermined time value and expires when the timer reaches the predetermined time value (when counting up) or expires when the time reaches zero (when counting down). As described above, the access information includes information indicative of a data logging duration. The telematics device 400 may determine the predetermined time value based on the data logging duration. In some embodiments, while the timer is active, the telematics device 400 logs additional data (e.g., as described above in process 712, process 714, process 716, process 718, and process 720). The additional data may correspond to the data type determined at process 710. In some embodiments, the telematics device 400 may create a new log file responsive to detecting a trigger event (e.g., as described above with respect to process 716).

At process 728, the telematics device 400 determines whether a stopping event has been detected. In some embodiments, the stopping event includes detecting and/or receiving a fault code. In some embodiments, the fault code may be the same fault code as described in process 710, process 712, and/or process 714. In other embodiments, the fault code is a different fault code. In some embodiments, the stopping event is based on a timer, such as the timer described in process 726. More specifically, telematics device 400 may determine that the stopping event has occurred responsive to determining that the timer started at process 726 has expired.

In some embodiments, the stopping event is a command received from the remote computing system 110. In some embodiments, the command may be generated by the remote computing system 110 responsive to receiving a user input. In some embodiments, the command may be generated by the remote computing system 110 responsive to receiving a user defined trigger. The user defined trigger may include, for example, detecting and/or receiving a fault code, detecting and/or receiving an indication that a fault code has changed from active to inactive, a user defined time duration, and/or other user defined triggers. Responsive to determining that the logging timer has not expired the method 700 continues to process 730. Responsive to determining that the logging timer has expired, the method 700 continues to process 740. Responsive to determining that the stopping event has not been detected the method 700 continues to process 730. Responsive to determining that the stopping event has been detected, the method 700 continues to process 740.

At process 730, the telematics device 400 determines whether a new log file has been created. For example, the telematics device 400 is configured to create a new log file responsive to detecting the trigger event (e.g., at process 716) while the logging timer is active. Responsive to determining that a new log file has been created, the method 700 continues to process 732. Responsive to determining that a new log file has not been created, the method 700 returns to process 726. At process 732, the telematics device 400 sends the new log file to the remote computing system 110.

At process 740, the telematics device 400 stops logging data. At process 742, the telematics device 400 sends a log file to the remote computing system 110. In some embodiments, the log file may include data stored in the buffer.

At process 744, the telematics device 400 compares the event counter value to an event counter threshold. Responsive to determining that the event counter is greater than the event counter threshold, the method 700 continues to process 746. Responsive to determining that the event counter is less than or equal to the event counter threshold, the method 700 continues to process 748 and ends.

At process 746, the telematics device 400 is configured to stop logging data. Responsive to stopping logging data, the telematics device 400 may delete the access information such that the telematics device 400 does not log additional data. Advantageously, by stopping the data logging, additional telematics data is not logged by the telematics device 400 thereby reducing the processing power and memory used by the telematics device 400. Responsive to ending the data logging configuration, the method 700 continues to process 748 and ends.

In an example operating embodiment, the remote computing system 110 may determine an issue and/or fault code that is of interest (e.g., via the issue tracking circuit 134 and/or a user input). For example, the remote computing system 110 may determine that a first issue is of interest. Responsive to determining that the first issue is of interest, the remote computing system 110 may determine a first group of vehicles 202 to receive telematics data from (e.g., via the vehicle clustering circuit 136). The remote computing system 110 may generate access information data packet for the vehicles 202 in the first group. The access information may define a level of access for the telematics device 400 of each vehicle 202, a data type, and/or a logging duration. In an example embodiment, the logging duration may define a four day period within the next two weeks that the telematics device 400 of a vehicle 202 should log data. In some embodiments, the data is logged by the telematics device automatically (e.g., without input from a user or the remote computing system) for a vehicle 202 of the fleet 200 that that experiences the first issue. The data type may define one or more operational data types or operational parameters for the telematics device 400 of each vehicle 202 to log. The remote computing system 110 may receive telematics data form one or more vehicles 202 in the first group that detected the first issue. Advantageously, the received telematics data includes data of the define data type and data from within the defined logging duration.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIGS. 1 and 3-4, it should be understood that the remote computing system 110, the controller 300, and/or the telematics device 400 may include any number of circuits for completing the functions described herein. For example, the activities and functionalities of the aftertreatment control circuit may be combined in multiple circuits or as a single circuit. Additional circuits with additional functionality may also be included. Further, the remote computing system 110, the controller 300, and/or the telematics device 400 may further control other activity beyond the scope of the present disclosure.

As mentioned above and in one configuration, the “circuits” may be implemented in machine-readable medium for execution by various types of processors, such as the processor 114 of FIG. 1, the processor 304 of FIG. 2, and/or the processor 404 of FIG. 4. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices.

While the term “processor” is briefly defined above, the term “processor” and “processing circuit” are meant to be broadly interpreted. In some embodiments, the one or more processors may be external to the apparatus (e.g., on-board vehicle controller), for example the one or more processors may be or included with a remote processor (e.g., a cloud based processor). In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on a local computer, partly on the local computer, as a stand-alone computer-readable package, partly on the local computer and partly on a remote computer, etc. In the latter scenario, the remote computer may be connected to the local computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A method for automatically logging telematics data for a fleet of vehicles, the method comprising:
receiving, by a processing circuit of a computing system, an indication of a first fault code from a first vehicle of the fleet of vehicles;
comparing, by the processing circuit, the first fault code to a list of fault codes stored in an issue database, wherein the issue database stores a frequency value for each fault code in the list of fault codes;
identifying, by the processing circuit, that the first fault code is a common fault code responsive to the frequency value of the first fault code being at or above a predetermined threshold;
generating, by the processing circuit, a first group of vehicles, the first group of vehicles comprising one or more vehicles of the fleet of vehicles;
generating, by the processing circuit, access information that causes a telematics device to log telematics data;
providing, by the processing circuit, the access information to each vehicle of the first group of vehicles, the access information structured to cause each vehicle of the first group of vehicles to generate telematics data;
receiving, by the processing circuit, the telematics data from one or more vehicles of the first group of vehicles; and
providing the telematics data to a user device.

2. The method of claim 1, wherein generating the first group of vehicles comprises:
receiving a plurality of engine output values corresponding to each vehicle in the fleet of vehicles, each engine output value of the plurality of engine output values corresponding to a predetermined period of time;
including each engine output value of the plurality of engine output values in one of a first bin corresponding to a first engine output range or a second bin corresponding to a second engine output range, different than the first engine output range, for each vehicle in the fleet of vehicles; and
including a vehicle of the fleet of vehicles in the first group of vehicles responsive to a first amount of the plurality of engine output values associated with the vehicle in the first bin being greater than a second amount of the plurality of engine output values associated with the vehicle in the second bin.

3. The method of claim 1, further comprising receiving, by the processing circuit, the frequency value of each fault code in the list of fault codes, the frequency value based on a number of instances that the processing circuit has received an indication of each fault code in the list of fault codes within a predetermined time period.

4. The method of claim 1, further comprising:
receiving, by the processing circuit, a request for the access information from the telematics device; and
generating, by the processing circuit, the access information responsive to receiving the request.

5. The method of claim 4, wherein the access information is generated responsive to the first fault code being identified as the common fault code.

6. The method of claim 1, further comprising providing, by the processing circuit, a stop command to each vehicle of the first group of vehicles, the stop command structured to prevent each vehicle of the first group of vehicles from generating the telematics data, the stop command provided responsive to at least one of:
receiving, from one or more vehicles in the first group of vehicles, a second fault code, different from the first fault code;
receiving, from one or more vehicles in the first group of vehicles, an indication that the first fault code changed from an active state to an inactive state; or
receiving an indication that a predefined time duration has elapsed.

7. The method of claim 1, further comprising:
receiving, by the processing circuit, a second fault code from a second vehicle of the fleet of vehicles;
comparing, by the processing circuit, the second fault code to the list of fault codes;
determining, by the processing circuit, that the second fault code is another common fault code responsive to the frequency value of the second fault code being at or above the predetermined threshold;
generating, by the processing circuit, a second group of vehicles, the second group of vehicles comprising one or more vehicles of the fleet of vehicles, different than the first group of vehicles and including at least the second vehicle; and
providing, by the processing circuit, the access information to the second group of vehicles.

8. A non-transitory computer readable media storing instructions that, when executed by one or more processors of a computing system, cause the computing system to perform operations comprising:
receiving access information from a remote computing system, the access information comprising information indicative of a data type and a logging duration;
logging telematics data that corresponds to the data type, wherein logging the telematics data comprises:
causing one or more sensors to provide the telematics data to the computing system;
storing a first set of the telematics data in a buffer for the logging duration;
monitoring for a first issue;
responsive to not detecting the first issue, causing the buffer to delete a portion of the first set of the telematics data; and
responsive to detecting the first issue, providing the telematics data to the remote computing system.

9. The non-transitory computer readable media of claim 8, wherein the instructions, when executed by the one or more processors, further cause operations comprising:
comparing a data size of the first set of the telematics data to a data size threshold; and
responsive to the data size of the first set of the telematics data being at or above the data size threshold, causing the buffer to delete the portion of the first set of the telematics data.

10. The non-transitory computer readable media of claim 8, wherein the instructions, when executed by the one or more processors, further cause operations comprising:
comparing one or more time stamps associated with the first set of the telematics data to a time stamp threshold; and
responsive to at least one time stamp of the one or more time stamps associated with the first set of the telematics data being at or above the time stamp threshold, causing the buffer to delete the portion of the first set of the telematics data.

11. The non-transitory computer readable media of claim 8, wherein the instructions, when executed by the one or more processors, further cause operations comprising discarding a second set of the telematics data responsive to the second set of the telematics data corresponding to a different data type, the second set of the telematics data different than the first set of the telematics data.

12. The non-transitory computer readable media of claim 8, wherein the instructions, when executed by the one or more processors, further cause operations comprising receiving a list of issues and a frequency value for each issue in the list of issues from the remote computing system, the first issue in the list of issues and having a first frequency value at or above a predefined threshold.

13. The non-transitory computer readable media of claim 12, wherein the instructions, when executed by the one or more processors, further cause operations comprising discarding a second set of the telematics data responsive to the second set of the telematics data corresponding to a second issue, different than the first issue, the second issue having a second frequency value below the predefined threshold, the second issue in the list of issues, and the second set of the telematics data different than the first set of the telematics data.

14. An apparatus for logging telematics data of a vehicle, the apparatus comprising:
one or more processors; and
one or more memory devices storing instructions that, when executed by the one or more processors, cause the one or more processors to:
receive access information from a remote computing system, the access information comprising information indicative of a data type and a logging duration;
log telematics data that corresponds to the data type, wherein logging the telematics data comprises:
storing the telematics data that corresponds to the data type in a buffer for the logging duration;
monitoring for a fault code;
responsive to not detecting the fault code, causing the buffer to delete a portion of the telematics data; and
responsive to detecting the fault code, providing the telematics data to the remote computing system.

15. The apparatus of claim 14, wherein the instructions, when executed by the one or more processors, further cause the one or more processors to:
transmit a request for the access information to the remote computing system responsive to an access level being unknown, the access information further comprising information indicative of the access level;
compare the access level to an access threshold;
log the telematics data responsive to the access level exceeding the access threshold; and
prevent the telematics data from being logged responsive to the access level not exceeding the access threshold.

16. The apparatus of claim 14, wherein the data type corresponds to at least one component of the vehicle, wherein the at least one component is associated with the fault code.

17. The apparatus of claim 14, wherein the instructions, when executed by the one or more processors, further cause the one or more processors to:
compare a data size of the telematics data that corresponds to the data type to a data size threshold; and
responsive to the data size of the telematics data that corresponds to the data type being at or above the data size threshold and not detecting the fault code, cause the buffer to delete the portion of the telematics data.

18. The apparatus of claim 14, wherein the instructions, when executed by the one or more processors, further cause the one or more processors to:
compare one or more time stamps associated with the telematics data that corresponds to the data type to a time stamp threshold; and
responsive to at least one time stamp of the one or more time stamps associated with the telematics data that corresponds to the data type being at or above the time stamp threshold and not detecting the fault code, cause the buffer to delete the portion of the telematics data that corresponds to the data type.

19. The apparatus of claim 14, wherein the instructions, when executed by the one or more processors, further cause the one or more processors to:
increase an event counter value responsive to detecting the fault code;
enable a data logging timer responsive to increasing the event counter value;
log additional telematics data that corresponds to the data type;
generate an additional log file responsive to detecting a second fault code while the data logging timer is enabled, the additional log file comprising the additional telematics data corresponding to the data type; and
provide the additional log file to the remote computing system.

20. The apparatus of claim 19, wherein the instructions, when executed by the one or more processors, further cause the one or more processors to:
compare the event counter value to a predefined threshold;
responsive to the event counter value being at or above the predefined threshold, prevent the additional telematics data from being logged; and
discard the access information thereby preventing future telematics data from being logged.
